(19) United States
(12) Patent Application Publication
(10) Pub. No.: US 2021/0030038 A1
(43) Pub. Date: Feb. 4, 2021

(54) LIQUID FUNCTIONALLY IMPROVED ISOMALT

(71) Applicant: Südzucker AG, Mannheim (DE)

(72) Inventor: Jörg Bernard, Albsheim (DE)

(21) Appl. No.: 16/967,941

(22) PCT Filed: Feb. 5, 2019
(86) PCT No.: PCT/EP2019/052720

§ 371 Date: Aug. 6, 2020

(30) Foreign Application Priority Data
Feb. 7, 2018 (DE) 10 2018 201 920.7

(51) Int. Cl. A23L 27/30; A23C 9/156; A23C 9/13; A23G 9/34; A23G 3/42; A23L 2/60; A23L 21/10; A23G 4/10

(52) U.S. Cl. CPC A23L 27/34; A23C 9/156; A23C 9/1307; A23G 9/34; A23L 33/20; A23L 2/60; A23L 21/10; A23G 4/10; A23G 3/42

(57) ABSTRACT

The present invention relates to a liquid isomalt composition comprising 6-O-alpha-D-glucopyranosyl-D-sorbitol (1,6-GPS) and 1-O-alpha-D-glucopyranosyl-D-mannitol (1,1-GPM) and the additional glycosylated isomalt components 1-O-(6′-O-alpha-D-glucopyranosyl)-alpha-D-glucopyranosyl-D-mannitol (6′-g-1, 1-GPM), 6-O-(6′-O-alpha-D-glucopyranosyl)-alpha-D-glucopyranosyl-D-sorbitol (6′-g-1,6-GPS), 1,6-di-O-alpha-D-glucopyranosyl-D-sorbitol (1-g-1,6-GPS) and 1,6-di-O-alpha-D-glucopyranosyl-D-mannitol (6-g-1,1-GPM).

The present invention relates to a liquid isomalt composition comprising 6-O-alpha-D-glucopyranosyl-D-sorbitol (1,6-GPS) and 1-O-alpha-D-glucopyranosyl-D-mannitol (1,1-GPM) and the additional glycosylated isomalt components 1-O-(6′-O-alpha-D-glucopyranosyl)-alpha-D-glucopyranosyl-D-mannitol (6′-g-1, 1-GPM), 6-O-(6′-O-alpha-D-glucopyranosyl)-alpha-D-glucopyranosyl-D-sorbitol (6′-g-1,6-GPS), 1,6-di-O-alpha-D-glucopyranosyl-D-sorbitol (1-g-1,6-GPS) and 1,6-di-O-alpha-D-glucopyranosyl-D-mannitol (6-g-1,1-GPM).

Isomalt (hydrogenated isomaltulose) is a sugar substitute which has 1,6-GPS and 1,1-GPM as the main constituents, and which is advantageous due to the acariogenicity, low calorific value and diabetic suitability thereof.

DE 25 20 173 A1 relates to a method for producing 1,6-GPS and 1,1-GPM from isomaltulose and the use thereof as a sugar substitute. EP 0 625 578 A1 discloses the production of isomalt and the use thereof as a sweetener in various luxury food and food products.

EP 0 859 006 B2 and WO 1997/008958 A1 relate to methods for producing mixtures enriched with 1,6-GPS and 1,1-GPM, as well as 1,6-GPS and 1,1-GPM in pure form, and uses thereof.

Such isomalt compositions are used in many products, for example, in luxury food and the food sector. Depending on the end product, the associated consumer preferences and technological requirements, the wide range of applications of isomalt compositions requires particular flexibility with regard to the provision of different product properties. Thus, certain end products and/or consumer preferences also require liquid isomalt compositions, particularly those which have a slight discoloration, particularly after storage of the isomalt compositions. The liquid isomalt compositions known so far can be improved in their tendency to discolor, particularly after storage of the isomalt compositions.

The invention is therefore based on the technical problem of providing a liquid isomalt composition comprising 1,1-GPM and 1,6-GPS, which shows no or very little discoloration, thus increased color stability.

The present invention solves the technical problem by providing a liquid isomalt composition, thus a liquid composition comprising 1,1-GPM and 1,6-GPS, wherein the liquid isomalt composition has 1,1-GPM, 1,6-GPS and the glycosylated isomalt components 6′-g-1,1-GPM, 6′-g-1,6-GPS, 1-g-1,6-GPS and 6-g-1,1-GPM, and wherein the weight ratio of 6′-g-1,1-GPM:6′-g-1,6-GPS:1-g-1,6-GPS:6-g-1,1-GPM in the isomalt composition is 1:(0.7-1.3):(0.3-1.1):(1-2), based on wt. % and dry substance (DS) of the glycosylated isomalt components.

The invention is based on the surprising finding that a liquid isomalt composition containing the glycosylated isomalt components 6′-g-1, 1-GPM (1-O-(6′-O-alpha-D-glucopyranosyl)-alpha-D-glucopyranosyl-D-mannitol), 6′-g-1,6-GPS (6-O-(6′-O-alpha-D-glucopyranosyl)-alpha-D-glucopyranosyl-D-sorbitol), 1-g-1,6-GPS (1,6-di-O-alpha-D-glucopyranosyl-D-sorbitol) and 6-g-1,1-GPM (1,6-di-O-alpha-D-glucopyranosyl-D-mannitol) in the specific weight ratio according to the invention, shows no or very little discoloration, particularly less discoloration compared to other isomalt compositions, particularly after storage. The four components 6′-g-1,1-GPM, 6′-g-1,6-GPS, 1-g-1,6-GPS and 6-g-1,1-GPM are hereinafter also referred to as “the glycosylated isomalt components.”

In a preferred embodiment of the present invention, the liquid isomalt composition has a content of at least one solvent of at least 5 wt. %, preferably at least 10 wt. %, preferably at least 15 wt. %, preferably at least 20 wt. %, preferably at least 25 wt. %, preferably at least 30 wt. %, preferably at least 40 wt. %, preferably at least 50 wt. %, preferably at least 60 wt. %, preferably at least 70 wt. %, preferably at least 80 wt. %, preferably at least 90 wt. %, preferably at least 92 wt. %, preferably at least 95 wt. %, preferably at least 98 wt. %, preferably at least 99 wt. %, preferably from 20 to 95 wt. %, preferably from 30 to 95 wt. %, preferably from 40 to 95 wt. %, preferably from 50 to 95 wt. %, preferably from 60 to 95 wt. %, preferably from 20 to 90 wt. %, preferably from 30 to 90 wt. %, preferably from 40 to 90 wt. %, preferably from 50 to 90 wt. %, preferably from 60 to 90 wt. %, preferably 20 to 80 wt. %, preferably 30 to 80 wt. %, preferably 40 to 80 wt. %, preferably 50 to 80 wt. %, preferably 20 to 70 wt. %, preferably 30 to 70 wt. %, preferably 30 to 60 wt. %, preferably 40 to 70 wt. %, or preferably 40 to 60 wt. %, each based on the total weight of the liquid isomalt composition.

In a preferred embodiment, the at least one solvent of the liquid isomalt composition according to the invention is water, an alcohol or a mixture thereof, preferably water, ethanol or a mixture thereof, particularly preferably water.

In a particularly preferred embodiment, the liquid isomalt composition according to the invention has, in addition to the glycosylated isomalt components and the at least one solvent alone, 1,1-GPM and 1,6-GPS, that is, consists of these components. In a further preferred embodiment, the liquid isomalt composition according to the invention has 1,1-GPM, 1,6-GPS and 1,1-GPS in addition to the glycosylated isomalt components and the at least one solvent alone, preferably additionally also mannitol, sorbitol, deoxy disaccharide alcohols, GPI and/or glucosylglycitols, that is, consists of these components. In a particularly preferred embodiment, it is provided that the liquid isomalt composition according to the invention has only the glycosylated isomalt components, which comprises at least one solvent, 1,1-GPM, 1,6-GPS, 1,1-GPS, mannitol, sorbitol, deoxy disaccharide alcohols, GPI and glucosylglycitols, that is, consists of these components and accordingly has no further substances or mixtures of substances.

The reduced discoloration, thus higher color stability, of the isomalt composition according to the invention is surprisingly maintained over a long period of time, particularly when the liquid isomalt composition is stored, particularly no or very little discoloration is observed, particularly a significantly lower discoloration compared to other isomalt compositions. Surprisingly, the liquid Isomalt composition according to the invention shows no or very little discoloration under the influence of light, particularly UV light, and at elevated temperatures. The isomalt composition according to the invention thus shows a higher storage stability, particularly under the influence of light and at an elevated temperature, particularly when stored at a temperature of 10 to 90° C., preferably 20 to 90° C., preferably 30 to 90° C., preferably 40 to 90° C., preferably 50 to 90° C., preferably 60 to 90° C.

The reduced discoloration of a liquid isomalt composition according to the invention is advantageous in a manner that allows for a longer shelf life of such compositions and products containing such compositions. Surprisingly, a liquid isomalt composition according to the invention is less prone to coloration. Surprisingly, a liquid isomalt composition according to the invention has a lower coloration, particularly a lower discoloration, particularly when the liquid isomalt composition is stored also for a longer period of time, for example, more than 2 weeks, more than 3 weeks, particularly more than 12 weeks. The shelf life of a liquid isomalt composition according to the invention is surprisingly increased.

In the context of the present invention, the term “discoloration” means a coloration of a composition which is visible or measurable in an optical manner, particularly a change in the coloration of a composition relative to the original coloration thereof.

In the context of the present invention, the term “color stability” means no or very little coloration, visible or measurable in an optical manner, particularly a change in coloration, of a composition.

The coloration can be measured as color in solution. Color in solution is the photometrically determined absorbance of a filtered solution, converted into ICUMSA units (based on ICUMSA method: GS2/3-9). The measurement occurs in a spectrophotometer, preferably a two-beam photometer, at a wavelength of 420 nm.

The photometric measurement of the absorbance can occur in a concentration range of the liquid sample between 5 g DS/100 mL water-40 g DS/100 mL water (DS: dry substance). For concentrated samples, a dilution of the sample occurs with demineralized water and is filtered through a filter having a pore size of 0.45 μm. Preferably, a 1:1 dilution of the concentrated sample occurs.

An isomalt solution having an initial value of the color in solution of <10 ICUMSA units is color stable according to in the meaning of the invention if at a storage temperature of 85° C. with a dry matter content of 75% after a storage period of 21 days the color in solution (photometrically determined absorbance converted into ICUMSA units) is below 30 ICUMSA units.

A sample solution having a dry substance content (refractometric) of 20% is adjusted by dilution with demineralized water. The solution obtained is added to a disposable syringe and filtered through a syringe filter (Sartorius Minisart®, 0.45 μm) into a cuvette made of optical glass (transmittance from 360 nm, path length 5 cm with lid), wherein the first 5 mL are discarded. The cuvette is covered and left to stand for 15 minutes. Subsequently, the absorbance (E₄₂₀) of this solution at 420 nm is measured in a spectrophotometer (e.g. from Hitachi, e.g. Hitachi U 2000, U 2001) against a comparison cuvette filled with water. The color in solution in ICUMSA units F_{IE} is obtained by calculation:

F_{IE}=1000×ε₄₂₀=1000×E₄₂₀/(d×c)
ε₄₂₀=extinction coefficient (at 420 nm)
E₄₂₀=extinction (at 420 nm)
d=layer thickness of the cuvette (5 cm)
c=concentration (g/mL)=ρ_{20%}×(DS/100)
TS=dry matter content (g/100 g, adjusted to 20 g/100 g)
ρ_{20%}=1.081 (density of a 20.0% measuring solution)

The filtration can be performed by vacuum filtration or with a syringe attachment filter. For vacuum filtration, a vacuum filtration device is used, e.g. Witt's pot, glass beaker, stainless steel frit with moistened membrane filter with an average pore diameter of 0.45 μm (e.g. cellulose nitrate membrane filter, Fa. Sartorius). The syringe attachment filter preferably has a pore size of 0.45 μm (e.g. cellulose acetate membrane filter, Minisart®, Sartorius).

In the context of the present invention, an isomalt composition is understood to be a composition having 1,1-GPM and 1,6-GPS.

In connection with the present invention, an isomalt composition according to the invention is understood to be a mixture having 1,1-GPM (1-O-alpha-D-glucopyranosyl-D-mannitol), 1,6-GPS (6-O-alpha-D-glucopyranosyl-D-sorbitol) and the glycosylated isomalt components 6′-g-1,1-GPM, 6′-g-1,6-GPS, 1-g-1,6-GPS and 6-g-1,1-GPM. In a preferred embodiment, the isomalt composition may also have other components such as 1,1-GPS (1-O-alpha-D-glucopyranosyl-D-sorbitol), deoxy disaccharide alcohols, glucosylglycitols, GPI, mannitol, sorbitol and/or other components occurring in small amounts.

In a preferred embodiment, the liquid isomalt composition according to the invention has a weight ratio of 6′-g-1.1-GPM:6-g-1,6-GPS:1-g-1,6-GPS:6-g-1,1-GPM of 1: (0.7-1.3): (0.3-1.1): (1.0-2.0), preferably of 1: (0.7-1.2): (0.5-1.0): (1.1-1.9), preferably of 1: (0.7-1.0): (0.6-1.0): (1.3-1.9), preferably of 1: (0.8-1.0): (0.7-1.0): (1,2-1,8), preferably of 1: (0.8-1.0): (0.8-1.0): (1.4-1.8), preferably of 1: (0.9-1.1): (0.9-1.1): (1.4-1.8), preferably of 1: (0.9-1.1): (1.1-1.4): (1.8-2.2), or preferably of 1: (0.9-1.1): (0.2-0.5): (1-1,2), each based on wt. % and dry substance (DS) of the glycosylated isomalt components.

In connection with the present invention, unless otherwise indicated and/or recognizable, the percentages of individual components indicated for a composition of components add up to 100 wt. % of the dry substance (DS) of the liquid composition.

In addition to 1,1-GPM, 1,6-GPS and the glycosylated isomalt components, the compositions according to the invention have at least one solvent, preferably water, an alcohol or a mixture thereof, in particular preferably water.

In a preferred embodiment, the liquid isomalt composition according to the invention has a dry substance content (DS) of at least 1 wt. %, preferably at least 2 wt. %, preferably at least 5 wt. %, preferably at least 10 wt. %, preferably at least 20 wt. %, preferably at least 30 wt. %, preferably at least 40 wt. %, preferably at least 50 wt. %, preferably at least 60 wt. %, preferably at least 70 wt. %, preferably at least 75 wt. %, preferably at least 80 wt. %, preferably at least 85 wt. %, preferably at least 90 wt. %, preferably 5 to 80 wt. %, preferably 5 to 70 wt. %, preferably 5 to 60 wt. %, preferably 5 to 50 wt. %, preferably 5 to 40 wt. %, preferably 10 to 80 wt. %, preferably 10 to 70 wt. %, preferably 10 to 60 wt. %, preferably 10 to 50 wt. %, preferably 10 to 40 wt. %, preferably 20 to 80 wt. %, preferably 20 to 70 wt. %, preferably 20 to 60 wt. %, preferably 20 to 50 wt. %, preferably 30 to 80 wt. %, preferably 30 to 70 wt. %, preferably 40 to 70 wt. %, preferably 30 to 60 wt. %, or preferably 40 to 60 wt. %, each based on the total weight of the liquid isomalt composition.

In a preferred embodiment, the liquid isomalt composition according to the invention is present at a temperature of 5 to 90° C., preferably 10 to 90° C., preferably 20 to 90° C., preferably 30 to 90° C., preferably 5 to 80° C., preferably 10 to 80° C., preferably 20 to 80° C., preferably 30 to 80° C., preferably 5 to 70° C., preferably 10 to 70° C., preferably 20 to 70° C., preferably 30 to 70° C., preferably 5 to 60° C., preferably 10 to 60° C., preferably 20 to 60° C., preferably 30 to 60° C., preferably 5 to 50° C., preferably 10 to 50° C., preferably 20 to 50° C., preferably 30 to 50° C., preferably 5 to 40° C., preferably 10 to 40° C., preferably 20 to 40° C., preferably 30 to 40° C., preferably 5 to 30° C., preferably 10 to 30° C., or preferably 20 to 30° C.

In a preferred embodiment, the liquid isomalt composition of the invention has a pH value of from 5 to 9, preferably from 5 to 8, preferably from 5 to 7, preferably from 6 to 9, preferably from 7 to 9, preferably from 6 to 8, or preferably from 6.5 to 7.5.

In a particularly preferred embodiment, the liquid isomalt composition according to the invention has, in addition to the at least one solvent, particularly water, only the glycosylated isomalt components and 1,1-GPM and 1,6-GPS.

In a particularly preferred embodiment, the liquid isomalt composition according to the invention has, in addition to the at least one solvent, particularly water, only the glycosylated isomalt components, 1,1-GPM and 1,6-GPS, preferably additionally also 1,1-GPS, mannitol, sorbitol, deoxy disaccharide alcohols, GPI and/or glucosylglycitols.

In a particularly preferred embodiment, the liquid isomalt composition according to the invention has, in addition to the glycosylated isomalt components, a mixture of 1,6-GPS and 1,1-GPM in a ratio of 43 to 57 wt. % of 1,6-GPS and 57 to 43 wt. % of 1,1-GPM (each based on dry substance (DS) of the total amount of 1,6-GPS and 1,1-GPM). In another preferred embodiment, the liquid isomalt composition of the invention has a mixture of 1,6-GPS and 1,1-GPM in a 1,1-GPM-enriched form, particularly one in which more than 57, preferably 57.1, or preferably 57.2 to 99 wt. % of 1,1-GPM and less than 43, preferably 42.9, or preferably 42.8 to 1 wt. % of 1,6-GPS are present (each based on dry matter (DS) of the total amount of 1,6-GPS and 1,1-GPM). In a further preferred embodiment, the liquid isomalt composition of the invention has a mixture of 1,6-GPS and 1,1-GPM in a 1,6-GPS-enriched form, particularly one in which more than 57, preferably 57.1, or preferably 57.2 to 99 wt. % of 1,6-GPS and less than 43, preferably 42.9, or preferably 42.8 to 1 wt. % of 1,1-GPM are present, particularly the mixture has 75 to 80 wt. % of 1,6-GPS and 25 to 20 wt. of 1,1-GPM (each based on dry substance (DS) of the total amount of 1,6-GPS and 1,1-GPM).

In a preferred embodiment, the liquid isomalt composition of the invention has at least 70 wt. % of 1,6-GPS and 1,1-GPM, preferably at least 80 wt. %, preferably at least 82 wt. %, preferably at least 84 wt. %, preferably at least 86 wt. %, preferably at least 88 wt. %, preferably at least 90 wt. %, preferably at least 92 wt. %, preferably at least 94 wt. %, preferably at least 96 wt. %, or preferably at least 98 wt. %, each based on the total weight (DS) of the liquid isomalt composition, wherein, in a particularly preferred embodiment, this mixture has 1,6-GPS and 1,1-GPM in the quantitative ratios to one another as disclosed above.

In a preferred embodiment, the liquid isomalt composition of the invention has at least 30 wt. % of 1,6-GPS, preferably at least 35 wt. %, preferably at least 40 wt. %, preferably at least 45 wt. %, preferably at least 50 wt. %, preferably at least 55 wt. %, preferably at least 60 wt. %, preferably at least 65 wt. %, preferably at least 70 wt. %, preferably at least 75 wt. %, preferably at most 90 wt. %, preferably at most 80 wt. %, preferably at most 70 wt. %, preferably at most 60 wt. %, preferably 40 to 90 wt. %, preferably 50 to 90 wt. %, preferably 60 to 90 wt. %, preferably 30 to 80 wt. %, preferably 40 to 80 wt. %, or preferably 50 to 80 wt. %, each based on the total weight (DS) of the liquid isomalt composition.

In a preferred embodiment, the liquid isomalt composition of the invention has at least 15 wt. % of 1,1-GPM, preferably at least 20 wt. %, preferably at least 25 wt. %, preferably at least 30 wt. %, preferably at least 35 wt. %, preferably at least 40 wt. %, preferably at least 45 wt. %, preferably at least 50 wt. %, preferably at least 55 wt. %, preferably at least 60 wt. %, preferably at least 65 wt. %, preferably at most 60 wt. %, preferably at most 50 wt. %, preferably at most 55 wt. %, preferably at most 45 wt. %, preferably at most 40 wt. %, preferably at most 35 wt. %, preferably at most 30 wt. %, preferably at most 25 wt. %, preferably 10 to 60 wt. %, preferably 20 to 60 wt. %, preferably 20 to 50 wt. %, preferably 20 to 40 wt. %, preferably 10 to 50 wt. %, preferably 10 to 40 wt. %, or preferably 10 to 30 wt. %, each based on the total weight (DS) of the liquid isomalt composition.

In a preferred embodiment, the liquid isomalt composition of the invention has, in addition to the at least one solvent, the components 1,6-GPS, 1,1-GPM, 6′-g-1,1-GPM, 6′-g-1,6-GPS, 1-g-1,6-GPS and 6-g-1,1-GPM and at least one further component selected from the group consisting of 1,1-GPS, deoxy disaccharide alcohols, GPI (glucopyranosyl idol), glucosylglycitols, mannitol and sorbitol, particularly consisting of the same.

In a particularly preferred embodiment, the liquid isomalt composition according to the invention has, in addition to the at least one solvent, the components 1,6-GPS, 1,1-GPM, 6′-g-1,1-GPM, 6′-g-1,6-GPS, 1-g-1,6-GPS and 6-g-1,1-GPM, particularly consisting of the same.

In a preferred embodiment, the liquid isomalt composition of the invention has 0.01 to 1 wt. % 6′-g-1,1-GPM, preferably 0.01 to 0.6 wt. %, preferably 0.01 to 0.4 wt. %, preferably 0.01 to 0.3 wt. %, preferably 0.01 to 0.2 wt. %, preferably 0.01 to 0.16 wt. %, preferably 0.01 to 0.14 wt. %, preferably 0.01 to 0.12 wt. %, preferably 0.01 to 0.1 wt. %, preferably 0.01 to 0.08 wt. %, preferably 0.03 to 1 wt. %, preferably 0.03 to 0.6 wt. %, preferably 0.03 to 0.4 wt. %, preferably 0.03 to 0.3 wt. %, preferably 0.03 to 0.2 wt. %, or preferably 0.03 to 0.1 wt. %, based on the total weight (DS) of the liquid isomalt composition.

In a preferred embodiment, the liquid isomalt composition of the invention has 0.01 to 1 wt. % of 6′-g-1,6-GPS, preferably 0.01 to 0.6 wt. %, preferably 0.01 to 0.4 wt. %, preferably 0.01 to 0.3 wt. %, preferably 0.01 to 0.2 wt. %, preferably 0.01 to 0.16 wt. %, preferably 0.01 to 0.14 wt. %, preferably 0.01 to 0.12 wt. %, preferably 0.01 to 0.1 wt. %, preferably 0.01 to 0.08 wt. %, preferably 0.03 to 1 wt. %, preferably 0.03 to 0.6 wt. %, preferably 0.03 to 0.4 wt. %, preferably 0.03 to 0.3 wt. %, preferably 0.03 to 0.2 wt. %, or preferably 0.03 to 0.1 wt. %, each based on the total weight (DS) of the liquid isomalt composition.

In a preferred embodiment, the liquid isomalt composition of the invention has 0.01 to 1 wt. % of 1-g-1,6-GPS, preferably 0.01 to 0.6 wt. %, preferably 0.01 to 0.4 wt. %, preferably 0.01 to 0.3 wt. %, preferably 0.01 to 0.2 wt. %, preferably 0.01 to 0.16 wt. %, preferably 0.01 to 0.14 wt. %, preferably 0.01 to 0.12 wt. %, preferably 0.01 to 0.1 wt. %, preferably 0.01 to 0.08 wt. %, preferably 0.03 to 1 wt. %, preferably 0.03 to 0.6 wt. %, preferably 0.03 to 0.4 wt. %, preferably 0.03 to 0.3 wt. %, preferably 0.03 to 0.2 wt. %, or preferably 0.03 to 0.1 wt. %, each based on the total weight (DS) of the liquid isomalt composition.

In a preferred embodiment, the liquid isomalt composition of the invention has 0.01 to 2 wt. % of 6-g-1,1-GPM, preferably from 0.01 to 1.8 wt. %, preferably from 0.02 to 1.6 wt. %, preferably from 0.03 to 1.4 wt. %, preferably from 0.01 to 1.6 wt. %, preferably 0.01 to 1.4 wt. %, preferably 0.01 to 1.2 wt. %, preferably 0.01 to 1 wt. %, preferably 0.01 to 0.6 wt. %, preferably 0.01 to 0.4 wt. %, preferably 0.01 to 0.3 wt. %, preferably 0.01 to 0.2 wt. %, preferably 0.01 to 0.16 wt. %, preferably 0.01 to 0.14 wt. %, preferably 0.01 to 0.12 wt. %, preferably 0.01 to 0.1 wt. %, preferably 0.01 to 0.08 wt. %, preferably 0.03 to 1 wt. %, preferably 0.03 to 0.6 wt. %, preferably 0.03 to 0.4 wt. %, preferably 0.03 to 0.3 wt. %, preferably 0.03 to 0.2 wt. %, or preferably 0.03 to 0.1 wt. %, each based on the total weight (DS) of the liquid isomalt composition.

In a preferred embodiment, the liquid isomalt composition of the invention has 97.5 to 99.5 wt. % of 1,6-GPS and 1,1-GPM and 0.06 to 0.9 wt. % of the glycosylated isomalt components 6′-g-1,1-GPM, 6′-g-1,6-GPS, 1-g-1,6-GPS and 6-g-1,1-GPM, preferably 97.7 to 99.3 wt. % of 1,6-GPS and 1,1-GPM and 0.08 to 0.8 wt. % of the glycosylated isomalt components, or preferably 97.9 to 99.1 wt. % of 1,6-GPS and 1,1-GPM and 0.1 to 0.7 wt. % of the glycosylated isomalt components, each based on the total weight (DS) of the liquid isomalt composition.

In a preferred embodiment, the liquid isomalt composition of the invention has 97.5 to 99.5 wt. % of 1,6-GPS and 1,1-GPM, 0.01 to 0.2 wt. % of 6′-g-1,1-GPM, 0.01 to 0.2 wt. % of 6′-g-1,6-GPS, 0.01 to 0.2 wt. % of 1-g-1,6-GPS and 0.01 to 0.4 wt. % of 6-g-1,1-GPM, preferably 97.7 to 99.3 wt. % of 1,6-GPS and 1,1-GPM, 0.02 to 0.18 wt. % of 6′-g-1,1-GPM, 0.02 to 0.18 wt. % of 6′-g-1,6-GPS, 0.02 to 0.18 wt. % of 1-g-1,6-GPS and 0.02 to 0.34 wt. % of 6-g-1,1-GPM, or preferably 97.9 to 99.1 wt. % of 1,6-GPS and 1,1-GPM, 0.03 to 1.6 wt. % of 6′-g-1,1-GPM, 0.03 to 1.6 wt. % of 6′-g-1,6-GPS, 0.03 to 1.6 wt. % of 1-g-1,6-GPS and 0.04 to 0.28 wt. % of 6-g-1,1-GPM, each based on the total weight (DS) of the liquid isomalt composition.

In a preferred embodiment, the liquid isomalt composition of the invention has 40 to 89 wt. % 1,6-GPS, 10 to 59 wt. % 1,1-GPM and 0.06 to 0.9 wt. % of the glycosylated isomalt components 6′-g-1,1-GPM, 6′-g-1,6-GPS, 1-g-1,6-GPS and 6-g-1,1-GPM, preferably 40 to 79 wt. % of 1,6-GPS, 20 to 59 wt. % of 1,1-GPM and 0.08 to 0.8 wt. % of the glycosylated isomalt components, or preferably 50 to 79 wt. % of 1,6-GPS, 20 to 49 wt. % of 1,1-GPM and 0.1 to 0.7 wt. % of the glycosylated isomalt components, each based on the total weight (DS) of the liquid isomalt composition.

In a preferred embodiment, the liquid isomalt composition according to the invention has, in addition to the at least one solvent, the components 1,6-GPS, 1,1-GPM, 6-g-1,1-GPM, 6′-g-1,6-GPS, 1-g-1,6-GPS, 6-g-1,1-GPM and 1,1-GPS (1-O-alpha-D-glucopyranosyl-D-sorbitol), particularly consisting of the same.

In a preferred embodiment, the liquid isomalt composition of the invention has 0.1 to 10 wt. % of 1,1-GPS, preferably 0.1 to 8 wt. %, preferably 0.1 to 6 wt. %, preferably 0.1 to 5 wt. %, preferably 0.1 to 4 wt. %, preferably 0.1 to 3 wt. %, preferably 0.1 to 2 wt. %, preferably 0.1 to 1 wt. %, preferably 0.1 to 0.8 wt. %, preferably 0.1 to 0.6 wt. %, preferably 0.1 to 0.4 wt. %, preferably 0.2 to 10 wt. %, preferably 0.2 to 8 wt. %, preferably 0.2 to 6 wt. %, preferably 0.2 to 5 wt. %, preferably 0.2 to 4 wt. %, preferably 0.2 to 3 wt. %, preferably 0.2 to 2 wt. %, preferably 0.2 to 1 wt. %, preferably 0.2 to 0.8 wt. %, preferably 0.2 to 0.6 wt. %, preferably 0.2 to 0.4 wt. %, preferably 0.5 to 10 wt. %, preferably 0.5 to 8 wt. %, preferably 0.5 to 6 wt. %, preferably 0.5 to 5 wt. %, preferably 0.5 to 4 wt. %, preferably 0.5 to 3 wt. %, preferably 0.5 to 2 wt. %, preferably 0.5 to 1 wt. %, preferably 0.5 to 0.8 wt. %, preferably 1 to 10 wt. %, preferably 1 to 8 wt. %, preferably 1 to 6 wt. %, preferably 1 to 5 wt. %, preferably 1 to 4 wt. %, preferably 1 to 3 wt. %, or preferably 1 to 2 wt. %, each based on the total weight (DS) of the liquid isomalt composition.

In a particularly preferred embodiment, the liquid isomalt composition of the invention does not contain 1,1-GPS.

In a preferred embodiment, the liquid isomalt composition according to the invention has the components 1,6-GPS, 1,1-GPM, 6′-g-1,1-GPM, 6′-g-1,6-GPS, 1-g-1,6-GPS, 6-g-1,1-GPM and deoxy disaccharide alcohols in addition to the at least one solvent, particularly consisting of the same.

In a preferred embodiment, the liquid isomalt composition of the invention has 0.01 to 2 wt. % deoxy disaccharide alcohols, preferably 0.01 to 1 wt. %, preferably 0.01 to 0.8 wt. %, preferably 0.01 to 0.6 wt. %, preferably 0.01 to 0.4 wt. %, preferably 0.01 to 0.2 wt. %, preferably 0.01 to 0.5 wt. %, preferably 0.01 to 0.1 wt. %, 0.03 to 1.0 wt. %, preferably 0.03 to 0.8 wt. %, preferably 0.03 to 0.6 wt. %, preferably 0.03 to 0.4 wt. %, preferably 0.03 to 0.2 wt. %, preferably 0.03 to 0.5 wt. %, preferably 0.03 to 0.1 wt. %, preferably 0.1 to 1 wt. %, preferably 0.1 to 2 wt. %, preferably 0.1 to 4 wt. %, preferably 0.1 to 8 wt. %, preferably 0.2 to 2 wt. %, preferably 0.4 to 1 wt. %, or preferably 0.4 to 2 wt. %, each based on the total weight (DS) of the liquid isomalt composition.

In a particularly preferred embodiment, the liquid isomalt composition of the invention does not contain deoxy disaccharide alcohols.

In a preferred embodiment, the liquid isomalt composition according to the invention has the components 1,6-GPS, 1,1-GPM, 6′-g-1,1-GPM, 6′-g-1,6-GPS, 1-g-1,6-GPS, 6-g-1,1-GPM and glucosylglycitols in addition to the at least one solvent, particularly consisting of the same.

In a preferred embodiment, the liquid isomalt composition of the invention has 0.01 to 2 wt. % glucosylglycitols, preferably 0.01 to 1 wt. %, preferably 0.01 to 0.8 wt. %, preferably 0.01 to 0.6 wt. %, preferably 0.01 to 0.5 wt. %, preferably 0.01 to 0.4 wt. %, preferably 0.01 to 0.2 wt. %, preferably 0.01 to 0.1 wt. %, 0.03 to 1.0 wt. %, preferably 0.03 to 2.0 wt. %, preferably 0.03 to 0.8 wt. %, preferably 0.03 to 0.6 wt. %, preferably 0.03 to 0.5 wt. %, preferably 0.03 to 0.4 wt. %, preferably 0.03 to 0.2 wt. %, preferably 0.03 to 0.1 wt. %, preferably 0.04 to 1.0 wt. %, preferably 0.04 to 2.0 wt. %, preferably 0.04 to 0.8 wt. %, preferably 0.04 to 0.6 wt. %, preferably 0.04 to 0.5 wt. %, preferably 0.04 to 0.4 wt. %, preferably 0.04 to 0.2 wt. %, preferably 0.04 to 0.1 wt. %, preferably 0.1 to 0.4 wt. %, preferably 0.1 to 0.6 wt. %, preferably 0.1 to 0.8 wt. %, preferably 0.1 to 1 wt. %, preferably 0.1 to 2 wt. %, preferably 0.1 to 4 wt. %, preferably 0.1 to 8 wt. %, preferably 0.2 to 2 wt. %, preferably 0.4 to 2 wt. %, or preferably 0.4 to 1 wt. %, each based on the total weight (DS) of the liquid isomalt composition.

In a particularly preferred embodiment, the liquid isomalt composition does not contain glucosylglycitols.

In a preferred embodiment, the liquid isomalt composition according to the invention has the components 1,6-GPS, 1,1-GPM, 6′-g-1,1-GPM, 6′-g-1,6-GPS, 1-g-1,6-GPS, 6-g-1,1-GPM and mannitol in addition to the at least one solvent, particularly consisting of the same.

In a preferred embodiment, the liquid isomalt composition of the invention has 0.01 to 0.3 wt. % mannitol, preferably 0.01 to 0.2 wt. %, preferably 0.01 to 0.16 wt. %, preferably 0.01 to 0.12 wt. %, preferably 0.01 to 0.1 wt. %, preferably 0.01 to 0.08 wt. %, preferably 0.01 to 0.06 wt. %, preferably 0.01 to 0.04 wt. %, preferably 0.02 to 0.3 wt. %, preferably 0.02 to 0.2 wt. %, preferably 0.02 to 0.16 wt. %, preferably 0.02 to 0.1 wt. %, preferably 0.02 to 0.06 wt. %, preferably 0.04 to 0.16 wt. %, preferably 0.04 to 0.2 wt. %, preferably 0.04 to 0.1 wt. %, preferably 0.04 to 0.08 wt. %, preferably 0.06 to 0.2 wt. %, preferably 0.06 to 0.14 wt. %, preferably 0.06 to 0.1 wt. %, or preferably 0.06 to 0.08 wt. %, each based on the total weight (DS) of the liquid isomalt composition.

In a particularly preferred embodiment, the liquid isomalt composition does not contain mannitol.

In a preferred embodiment, the liquid isomalt composition according to the invention has the components 1,6-GPS, 1,1-GPM, 6′-g-1,1-GPM, 6′-g-1,6-GPS, 1-g-1,6-GPS, 6-g-1,1-GPM and sorbitol in addition to the at least one solvent, particularly consisting of the same.

In a preferred embodiment, the liquid isomalt composition of the invention has 0.01 to 0.4 wt. % sorbitol, preferably 0.01 to 0.3 wt. %, preferably 0.01 to 0.24 wt. %, preferably 0.01 to 0.2 wt. %, preferably 0.01 to 0.1 wt. %, preferably 0.01 to 0.06 wt. %, preferably 0.02 to 0.3 wt. %, preferably 0.02 to 0.2 wt. %, preferably 0.02 to 0.1 wt. %, preferably 0.02 to 0.06 wt. %, preferably 0.04 to 0.3 wt. %, preferably 0.04 to 0.24 wt. %, preferably 0.04 to 0.2 wt. %, preferably 0.04 to 0.1 wt. %, preferably 0.04 to 0.08 wt. %, preferably 0.06 to 0.24 wt. %, preferably 0.06 to 0.2 wt. %, preferably 0.06 to 0.14 wt. %, preferably 0.06 to 0.1 wt. %, or preferably 0.06 to 0.08 wt. %, each based on the total weight (DS) of the liquid isomalt composition.

In a particularly preferred embodiment, the liquid isomalt composition does not contain sorbitol.

In a preferred embodiment, the liquid isomalt composition according to the invention has the components 1,6-GPS, 1,1-GPM, 6′-g-1,1-GPM, 6′-g-1,6-GPS, 1-g-1,6-GPS, 6-g-1,1-GPM and GPI (glucopyranosyl-idite) in addition to the at least one solvent, particularly consisting of the same.

In a preferred embodiment, the liquid isomalt composition of the invention has 0.01 to 0.2 wt. % GPI, preferably 0.01 to 0.16 wt. %, preferably 0.01 to 0.12 wt. %, preferably 0.01 to 0.1 wt. %, preferably 0.01 to 0.08 wt. %, preferably 0.01 to 0.06 wt. %, preferably 0.01 to 0.04 wt. %, preferably 0.02 to 0.3 wt. %, preferably 0.02 to 0.2 wt. %, preferably 0.02 to 0.16 wt. %, preferably 0.02 to 0.1 wt. %, preferably 0.02 to 0.06 wt. %, preferably 0.04 to 0.16 wt. %, preferably 0.04 to 0.2 wt. %, preferably 0.04 to 0.1 wt. %, preferably 0.04 to 0.08 wt. %, preferably 0.06 to 0.2 wt. %, preferably 0.06 to 0.14 wt. %, or preferably 0.06 to 0.1 wt. %, each based on the total weight (DS) of the liquid isomalt composition.

In a particularly preferred embodiment, the liquid isomalt composition does not contain GPI.

In a preferred embodiment, the liquid isomalt composition of the invention has at least one sweetness enhancer.

In the context of the present invention, a sweetness enhancer is understood to be a substance which, unlike intensive sweeteners, itself has no or very little sweet taste, i.e. no or very little intrinsic sweetness, but which can enhance the sweetness of another sweet substance.

In a preferred embodiment, the liquid isomalt composition of the invention contains no colorants.

In a particularly preferred embodiment, the liquid isomalt composition of the invention is colorless or substantially colorless, i.e. it has no or very little color produced by the components of the liquid isomalt composition of the invention.

The present invention also provides for the use of the liquid isomalt composition according to the invention in products for human and/or animal consumption, preferably the product for human and/or animal consumption is a food or luxury food or a pharmaceutical product.

In a preferred embodiment, the food or luxury food is a confectionery, a filling for confectionery, a soft caramel, a hard caramel, a fondant, a yogurt, a pastry, a chewing gum, an ice cream, milk, a dairy product, a beverage, an isotonic drink, a protein shake, a fruit juice, a fruit juice concentrate, a fruit preparation, a jam, a jelly or a smoothie.

In a preferred embodiment, the pharmaceutical product is a pastille, tablet, compress, solution, juice, suspension, syrup, concentrate, dragée, hard or soft caramel, spray, or inhalation mixture.

In a particularly preferred embodiment, the liquid isomalt composition according to the invention is used for the coating of food or luxury foods or pharmaceutical products, particularly for coating chewing gums.

In a preferred embodiment, the food or luxury food has at least 1, 2, 3, 4, 5, 6, 7, 8, 9, 10, 20, 30, 40, 50, 60, 70, 80, 90, 95, 98, particularly 99 wt. % of the liquid isomalt composition according to the invention, based on the total weight (DS) of the food or luxury food.

The liquid isomalt compositions according to the invention can be produced, for example, by isolating particularly the glycosylated isomalt components individually by means of chromatographic methods from conventional isomalt compositions known per se, as described for example in EP 0 625 578 A1. This document is fully included in the disclosure of the present invention with respect to the description of the production of an isomalt composition referred to therein as a sweetener and the composition thereof.

In preferred embodiment, the isolated, separately present glycosylated isomalt components (6′-g-1,1-GPM, 6′-g-1,6-GPS, 1-g-1,6-GPS and 6-g-1,1-GPM) can be used to produce the liquid isomalt compositions according to the invention in the weight ratios and quantities of the individual components thereof provided for in the invention, with one another and with further components, particularly 1,1-GPM, 1,6-GPS and optionally 1,1-GPS, and converted into liquid form by means of a solvent, preferably an aqueous solvent, particularly water.

Further advantageous embodiments of the invention result from the subclaims.

The invention is explained in more detail by way of embodiments.

### EXAMPLE 1

Production of Liquid Isomalt Compositions According to the Invention

For the preparation of both liquid isomalt compositions according to the invention and liquid comparative isomalt compositions, crystalline isomalt-based mixtures were prepared in a first step as described below. These had 1,6-GPS and 1,1-GPM in an equimolar ratio of 43 to 57 wt. % 1,6-GPS to 57 to 43 wt. % 1,1-GPM and are referred to below as Isomalt-ST-based compositions (Isomalt-ST base) (see Table 1). In addition, crystalline isomalt compositions and comparative isomalt compositions were prepared that have 1,6-GPS and 1,1-GPM in a ratio of 70 to 80 wt. % 1,6-GPS to 30 to 20 wt. % 1,1-GPM and are referred to as isomalt GS-based compositions (Isomalt-GS base) (see Table 1).

For the preparation of the aforementioned crystalline isomalt compositions, an isomalt composition described therein as hydrogenated isomerized sucrose (sweetener) was prepared according to Example 1 of EP 0 625 578 A1 and a chromatographic separation of the components 1,1-GPM, 1,6-GPS, 1,1-GPS, 6′-g-1,1-GPM, 6′-g-1,6-GPS, 1-g-1,6-GPS, 6-g-1,1-GPM, deoxy disaccharide alcohol fraction and glycosylglycitol fraction. The individual components obtained after the separation in isolated form were mixed with commercially available mannitol and sorbitol in the quantities and proportions shown in Table 1 below to obtain substantially crystalline mixtures. Starting from the crystalline isomalt compositions prepared in this manner (samples 17 to 32, Table 1) and comparative isomalt compositions (samples 1 to 16, Table 1), aqueous solutions having a dry substance content of 75 wt. % based on the total weight of the solution were prepared in a further step according to the invention.

Sample 3 (comparative isomalt composition) can also be obtained by applying the method conditions mentioned in Example 1 of EP 0 625 578 A1 to an isomerized sucrose solution and subsequent chromatographic purification.

Both the comparative liquid isomalt compositions and the liquid isomalt compositions according to the invention have identical components, particularly the isomalt compositions are characterized by the presence of the four glycosylated isomalt components. The isomalt compositions according to the invention are distinguished from the comparative isomalt compositions particularly by different quantitative ratios of the four glycosylated isomalt components to one another.

TABLE 1

| | | 6-G-1.1 | 6-G-1.6 | 1-G-1.6 | 6-G-1.1 | | | | | | |
|---|---|---|---|---|---|---|---|---|---|---|---|
| | | GPM | GPS | GPS | GPM | | | | | | |
| | | g/100 | g/100 | g/100 | g/100 | | | | | | |
| | Sample | g DS | g DS | g DS | g DS | | | | | | |
| | number | GC analysis | | | | Ratio | | | | | |
| | Isomalt | | | | | | | | | | |
| | ST base | | | | | | | | | | |
| Comparison | 1 | 0.06 | 0.03 | 0.01 | 0.05 | 1 | : | 0.5 | : | 0.2 | : |
| | 2 | 0.02 | 0.03 | 0.05 | 0.08 | 1 | : | 1.5 | : | 2.5 | : |
| | 3 | 0.02 | 0.02 | 0.04 | 0.06 | 1 | : | 1.0 | : | 2.0 | : |
| | 4 | 0.06 | 0.11 | 0.12 | 0.19 | 1 | : | 1.8 | : | 2.0 | : |
| | 5 | 0.12 | 0.13 | 0.19 | 0.2 | 1 | : | 1.1 | : | 1.6 | : |
| | 6 | 0.05 | 0.03 | 0.04 | 0.12 | 1 | : | 0.6 | : | 0.8 | : |
| | 7 | 0.14 | 0.18 | 0.23 | 0.09 | 1 | : | 1.3 | : | 1.6 | : |
| | 8 | 0.04 | 0.06 | 0.05 | 0.09 | 1 | : | 1.5 | : | 1.3 | : |
| | Isomalt | | | | | | | | | | |
| | GS base | | | | | | | | | | |
| | 9 | 0.07 | 0.04 | 0.01 | 0.06 | 1 | : | 0.6 | : | 0.1 | : |
| | 10 | 0.03 | 0.05 | 0.1 | 0.11 | 1 | : | 1.7 | : | 3.3 | : |
| | 11 | 0.04 | 0.05 | 0.12 | 0.13 | 1 | : | 1.3 | : | 3.0 | : |
| | 12 | 0.09 | 0.13 | 0.13 | 0.24 | 1 | : | 1.4 | : | 1.4 | : |
| | 13 | 0.16 | 0.14 | 0.21 | 0.28 | 1 | : | 0.9 | : | 1.3 | : |
| | 14 | 0.05 | 0.06 | 0.08 | 0.09 | 1 | : | 1.2 | : | 1.6 | : |
| | 15 | 0.04 | 0.06 | 0.04 | 0.11 | 1 | : | 1.5 | : | 1.0 | : |
| | 16 | 0.09 | 0.13 | 0.11 | 0.19 | 1 | : | 1.4 | : | 1.2 | : |
| Invention | Isomalt | | | | | | | (0.7- | | (0.3- | |
| | ST base | | | | | 1 | | 1.3) | | 1.1) | |
| | 17 | 0.07 | 0.05 | 0.02 | 0.07 | 1 | : | 0.7 | : | 0.3 | : |
| | 18 | 0.02 | 0.02 | 0.01 | 0.03 | 1 | : | 1.0 | : | 0.5 | : |
| | 19 | 0.08 | 0.1 | 0.08 | 0.15 | 1 | : | 1.3 | : | 1.0 | : |
| | 20 | 0.18 | 0.13 | 0.16 | 0.26 | 1 | : | 0.7 | : | 0.9 | : |
| | 21 | 0.02 | 0.02 | 0.02 | 0.03 | 1 | : | 1.0 | : | 1.0 | : |
| | 22 | 0.07 | 0.07 | 0.06 | 0.08 | 1 | : | 1.0 | : | 0.9 | : |
| | 23 | 0.06 | 0.07 | 0.06 | 0.11 | 1 | : | 1.2 | : | 1.0 | : |
| | 24 | 0.11 | 0.14 | 0.12 | 0.22 | 1 | : | 1.3 | : | 1.1 | : |
| | Isomalt | | | | | | | | | | |
| | GS base | | | | | | | | | | |
| | 25 | 0.09 | 0.06 | 0.03 | 0.09 | 1 | : | 0.7 | : | 0.3 | : |
| | 26 | 0.05 | 0.04 | 0.04 | 0.08 | 1 | : | 0.8 | : | 0.8 | : |
| | 27 | 0.13 | 0.12 | 0.13 | 0.21 | 1 | : | 0.9 | : | 1.0 | : |
| | 28 | 0.15 | 0.15 | 0.11 | 0.18 | 1 | : | 1.0 | : | 0.7 | : |
| | 29 | 0.03 | 0.03 | 0.04 | 0.06 | 1 | : | 1.0 | : | 1.3 | : |
| | 30 | 0.06 | 0.07 | 0.05 | 0.08 | 1 | : | 1.2 | : | 0.8 | : |
| | 31 | 0.03 | 0.04 | 0.02 | 0.05 | 1 | : | 1.3 | : | 0.7 | : |
| | 32 | 0.08 | 0.1 | 0.09 | 0.16 | 1 | : | 1.3 | : | 1.1 | : |
| | | | | | | | | | Deoxy | | Total 1,1- |
| | | | | 1,1- | 1,6- | 1,1- | | | disaccharide | Glucosyl | GPM + |
| | | | | GPM | GPS | GPS | Mannitol | Sorbitol | alcohols | glycitols | 1,6-GPS |
| | | | | g/100 | g/100 | g/100 | g/100 | g/100 | g/100 | g/100 | g/100 |
| | | Sample | | g DS | g DS | g DS | g DS | g DS | g DS | g DS | g DS |
| | | number | Ratio | GC analysis | | | | | | | |
| | | Isomalt | | | | | | | | | |
| | | ST base | | | | | | | | | |
| | Comparison | 1 | 0.8 | 47.8 | 50.8 | 0.31 | 0.05 | 0.15 | 0.3 | 0.25 | 98.6 |
| | | 2 | 4.0 | 48.9 | 50.3 | 0.27 | 0.05 | 0.09 | 0.07 | 0.12 | 99.2 |
| | | 3 | 3.0 | 48.3 | 50.5 | 0.25 | 0.04 | 0.08 | 0.09 | 0.02 | 98.8 |
| | | 4 | 3.2 | 47.8 | 51.1 | 0.27 | 0.08 | 0.12 | 0.1 | 0.04 | 98.9 |
| | | 5 | 1.7 | 48.1 | 50.5 | 0.28 | 0.03 | 0.07 | 0.09 | 0.03 | 98.6 |
| | | 6 | 2.4 | 47.7 | 50.6 | 0.36 | 0.04 | 0.09 | 0.14 | 0.24 | 98.3 |
| | | 7 | 0.6 | 47.2 | 51.4 | 0.23 | 0.04 | 0.13 | 0.08 | 0.03 | 98.6 |
| | | 8 | 2.3 | 44.8 | 53.7 | 0.24 | 0.03 | 0.09 | 0.07 | 0.02 | 98.5 |
| | | Isomalt | | | | | | | | | |
| | | GS base | | | | | | | | | |
| | | 9 | 0.9 | 23.6 | 75.1 | 0.46 | 0.05 | 0.16 | 0.17 | 0.2 | 98.7 |
| | | 10 | 3.7 | 22.4 | 76.2 | 0.43 | 0.04 | 0.11 | 0.1 | 0.24 | 98.6 |
| | | 11 | 3.3 | 22.4 | 76.2 | 0.37 | 0.06 | 0.18 | 0.07 | 0.03 | 98.6 |
| | | 12 | 2.7 | 22.6 | 76 | 0.41 | 0.07 | 0.17 | 0.09 | 0.01 | 98.6 |
| | | 13 | 1.8 | 23 | 75.2 | 0.55 | 0.05 | 0.13 | 0.14 | 0.05 | 98.2 |
| | | 14 | 1.8 | 22.9 | 75.5 | 0.57 | 0.05 | 0.15 | 0.12 | 0.09 | 98.4 |
| | | 15 | 2.8 | 22.6 | 75.9 | 0.4 | 0.04 | 0.13 | 0.1 | 0.04 | 98.5 |
| | | 16 | 2.1 | 22.5 | 76.2 | 0.35 | 0.04 | 0.12 | 0.12 | 0.08 | 98.7 |
| | Invention | Isomalt | (1- | | | | | | | | |
| | | ST base | 2) | | | | | | | | |
| | | 17 | 1.0 | 47 | 50.7 | 0.3 | 0.05 | 0.1 | 0.1 | 0.38 | 97.7 |
| | | 18 | 1.5 | 47.3 | 51.9 | 0.29 | 0.04 | 0.1 | 0.1 | 0.13 | 99.2 |
| | | 19 | 1.9 | 48.3 | 50.5 | 0.21 | 0.03 | 0.08 | 0.08 | 0.14 | 98.8 |
| | | 20 | 1.4 | 49.9 | 48 | 0.22 | 0.05 | 0.13 | 0.09 | 0.33 | 97.9 |
| | | 21 | 1.5 | 47.8 | 51.1 | 0.33 | 0.05 | 0.11 | 0.13 | 0.27 | 98.9 |
| | | 22 | 1.1 | 47.5 | 50.9 | 0.36 | 0.07 | 0.17 | 0.21 | 0.2 | 98.4 |
| | | 23 | 1.8 | 48.7 | 50.2 | 0.24 | 0.03 | 0.06 | 0.05 | 0.14 | 98.9 |
| | | 24 | 2.0 | 48.1 | 50.6 | 0.22 | 0.07 | 0.13 | 0.12 | 0.06 | 98.7 |
| | | Isomalt | | | | | | | | | |
| | | GS base | | | | | | | | | |
| | | 25 | 1.0 | 21 | 77.1 | 0.38 | 0.04 | 0.12 | 0.08 | 0.1 | 98.1 |
| | | 26 | 1.6 | 22.7 | 76 | 0.49 | 0.07 | 0.2 | 0.09 | 0.12 | 98.7 |
| | | 27 | 1.6 | 22.7 | 75.8 | 0.44 | 0.05 | 0.17 | 0.12 | 0.09 | 98.5 |
| | | 28 | 1.2 | 22.1 | 76.1 | 0.46 | 0.09 | 0.22 | 0.16 | 0.26 | 98.2 |
| | | 29 | 2.0 | 20.6 | 78 | 0.37 | 0.05 | 0.16 | 0.11 | 0.08 | 98.6 |
| | | 30 | 1.3 | 22.3 | 76.5 | 0.38 | 0.04 | 0.14 | 0.13 | 0.11 | 98.8 |
| | | 31 | 1.7 | 22.4 | 75.9 | 0.41 | 0.08 | 0.3 | 0.23 | 0.24 | 98.3 |
| | | 32 | 2.0 | 22.1 | 76.1 | 0.47 | 0.06 | 0.15 | 0.12 | 0.18 | 98.2 |

### EXAMPLE 2

Examination of Discoloration During Storage

The liquid isomalt compositions produced in example 1 were each stored in 10 L canisters at a temperature of 85° C. for a total of 21 days. After 0, 2, 4, 7, 12, 14 and 21 days a small partial amount was taken to measure the color of the solution according to the International Commission for Uniform Methods of Sugar Analysis (ICUMSA, based on method GS2/3-9).

A sample solution having a dry substance content (refractometric) of 20% is adjusted by dilution with demineralized water. The solution obtained is added to a disposable syringe and filtered through a syringe filter (Sartorius Minisart®, 0.45 μm) into a cuvette made of optical glass (transmittance from 360 nm, path length 5 cm with lid), wherein the first 5 mL are discarded. The cuvette is covered and left to stand for 15 minutes. The absorbance (E₄₂₀) of this solution is then measured in a spectrophotometer (Hitachi) at 420 nm against a reference cuvette filled with water. The color in solution in ICUMSA units F_{IE} is obtained by calculation:

F_{IE}=1000×ε₄₂₀=1000×E₄₂₀/(d×c)
ε₄₂₀=extinction coefficient
E₄₂₀=extinction (at 420 nm)
d=layer thickness of the cuvette (5 cm)
c=concentration (g/mL)=ρ_{20%}×(DS/100)
TS=dry matter content (g/100 g, adjusted to 20 g/100 g)
ρ_{20%}=1.081 (density of a 20.0% measuring solution)

As can be seen from Table 2 below, the liquid isomalt compositions according to the invention (samples 17 to 32) were observed to have a significantly lower discoloration during storage time than the comparative isomalt compositions (samples 1 to 16). The comparative isomalt compositions showed a distinct yellowish tinge after 21 days, whereas the isomalt compositions according to the invention showed only a weak yellow coloration. The liquid isomalt compositions according to the invention showed a noticeably delayed tendency to discolor and therefore proved to be significantly more stable during storage.

TABLE 2
Storage test-examination of the discoloration

| | | Color in solution (filtered) | | | | | | | |
|---|---|---|---|---|---|---|---|---|---|
| | | Storage time at 85° C. (days) | | | | | | | |
| | Sample | 0 | 2 | 4 | 7 | 12 | 14 | 21 | |
| | number | ICUMSA units | | | | | | | Comment |
| | Isomalt ST base (solution in water with 75% DS) | | | | | | | | |
| Comparison | 1 | <10 | <10 | 12 | 15 | 26 | 29 | 39 | clear |
| | 2 | <10 | <10 | 16 | 18 | 22 | 34 | 42 | yellow |
| | 3 | <10 | 12 | 17 | 21 | 24 | 31 | 38 | tinge |
| | 4 | <10 | <10 | 14 | 23 | 29 | 38 | 47 | after |
| | 5 | <10 | 14 | 16 | 24 | 27 | 38 | 53 | 21 days |
| | 6 | <10 | <10 | 15 | 19 | 26 | 34 | 42 | |
| | 7 | <10 | <10 | 14 | 19 | 28 | 37 | 46 | |
| | 8 | <10 | <10 | 13 | 16 | 21 | 32 | 38 | |
| | Isomalt GS base (solution in water with 75% DS) | | | | | | | | |
| | 9 | <10 | <10 | 13 | 17 | 24 | 31 | 36 | clear |
| | 10 | <10 | <10 | <10 | 13 | 26 | 32 | 38 | yellow |
| | 11 | <10 | <10 | <10 | 17 | 28 | 32 | 41 | tinge |
| | 12 | <10 | <10 | 12 | 14 | 21 | 29 | 34 | after |
| | 13 | <10 | <10 | 12 | 17 | 26 | 32 | 39 | 21 days |
| | 14 | <10 | <10 | <10 | 14 | 27 | 30 | 37 | |
| | 15 | <10 | 13 | 18 | 23 | 29 | 33 | 43 | |
| | 16 | <10 | <10 | 12 | 18 | 27 | 34 | 38 | |
| Invention | Isomalt ST base (solution in water with 75% DS) | | | | | | | | |
| | 17 | <10 | <10 | 13 | 15 | 16 | 21 | 26 | only |
| | 18 | <10 | <10 | <10 | 12 | 17 | 19 | 24 | slight |
| | 19 | <10 | <10 | <10 | 11 | 14 | 18 | 21 | yellow |
| | 20 | <10 | <10 | <10 | 16 | 17 | 21 | 25 | coloration |
| | 21 | <10 | <10 | 12 | 14 | 15 | 20 | 23 | after |
| | 22 | <10 | <10 | <10 | 12 | 19 | 24 | 28 | 21 days |
| | 23 | <10 | <10 | <10 | 13 | 17 | 21 | 26 | |
| | 24 | <10 | <10 | <10 | 12 | 16 | 19 | 24 | |
| | Isomalt GS base (solution in water with 75% DS) | | | | | | | | |
| | 25 | <10 | <10 | <10 | <10 | 12 | 18 | 22 | only |
| | 26 | <10 | <10 | <10 | 13 | 15 | 20 | 24 | slight |
| | 27 | <10 | <10 | <10 | <10 | 14 | 16 | 20 | yellow |
| | 28 | <10 | <10 | <10 | 14 | 19 | 22 | 25 | coloration |
| | 29 | <10 | <10 | <10 | 13 | 18 | 23 | 28 | after |
| | 30 | <10 | <10 | <10 | 14 | 17 | 22 | 26 | 21 days |
| | 31 | <10 | <10 | <10 | <10 | 12 | 16 | 21 | |
| | 32 | <10 | <10 | <10 | <10 | 13 | 15 | 19 | |

1. A liquid isomalt composition, comprising glycosylated isomalt components 1-O-(6′-O-alpha-D-glucopyranosyl)-alpha-D-glucopyranosyl-D-mannitol (6′-g-1,1-GPM), 6-O-(6′-O-alpha-D-glucopyranosyl)-alpha-D-glucopyranosyl-D-sorbitol (6′-g-1,6-GPS), 1,6-di-O-alpha-D-glucopyranosyl-D-sorbitol (1-g-1,6-GPS) and 1,6-di-O-alpha-D-glucopyranosyl-D-mannitol (6-g-1,1-GPM), wherein the weight ratio of 6′-g-1,1-GPM:6′-g-1,6-GPS:1-g-1,6-GPS:6-g-1,1-GPM in the liquid isomalt composition is 1:(0.7-1.3):(0.3-1.1):(1-2) (each based on wt. % and dry substance (DS) of the glycosylated isomalt components).

2. The liquid isomalt composition according to claim 1, wherein the weight ratio of 6′-g-1,1-GPM:6′-g-1,6-GPS:1-g-1,6-GPS:6-g-1,1-GPM in the liquid isomalt composition is 1:(0.8-1):(0.7-1):(1.2-1.8).

3. The liquid isomalt composition according to claim 1, wherein the liquid isomalt composition comprises 0.01 to 0.2 wt. % 6′-g-1,1-GPM based on the total weight (DS) of the liquid isomalt composition.

4. The liquid isomalt composition according to claim 1, wherein the liquid isomalt composition comprises 0.01 to 0.2 wt. % of 6′-g-1,6-GPS based on the total weight (DS) of the liquid isomalt composition.

5. The liquid isomalt composition according to claim 1, wherein the liquid isomalt composition comprises 0.01 to 0.2 wt. % of 1-g-1,6-GPS based on the total weight (DS) of the liquid isomalt composition.

6. The liquid isomalt composition according to claim 1, wherein the liquid isomalt composition comprises 0.01 to 0.4 wt. % of 6-g-1,1-GPM based on the total weight (DS) of the liquid isomalt composition.

7. The liquid isomalt composition according to claim 1, wherein the liquid isomalt composition comprises at least 86 wt. % of 1,6-GPS and 1,1-GPM based on the total weight (DS) of the liquid isomalt composition.

8. The liquid isomalt composition according to claim 1, wherein the liquid isomalt composition comprises at least 40 wt. % 1,6-GPS based on the total weight (DS) of the liquid isomalt composition.

9. The liquid isomalt composition according to claim 1, wherein the liquid isomalt composition comprises 0.1 to 1.0 wt. % 1,1-GPS (1-O-alpha-glucopyranosyl-D-sorbitol) based on the total weight (DS) of the liquid isomalt composition.

10. The liquid isomalt composition according to claim 1, wherein the liquid isomalt composition comprises 0.01 to 2.0 wt. % deoxy disaccharide alcohols based on the total weight (DS) of the liquid isomalt composition.

11. The liquid isomalt composition according to claim 1, wherein the liquid isomalt composition comprises 0.01 to 2.0 wt. % of glucosylglycitols based on the total weight (DS) of the liquid isomalt composition.

12. The liquid isomalt composition according to claim 1, wherein the liquid isomalt composition comprises 0.01 to 0.3 wt. % of mannitol based on the total weight (DS) of the liquid isomalt composition.

13. The liquid isomalt composition according to claim 1, wherein the liquid isomalt composition comprises 0.01 to 0.4 wt. % sorbitol based on the total weight (DS) of the liquid isomalt composition.

14. The liquid isomalt composition according to claim 1, wherein the liquid isomalt composition comprises at least 5 wt. % dry matter content based on the total weight of the liquid isomalt composition.

15. The liquid isomalt composition according to claim 1, wherein the liquid isomalt composition comprises at least 10 to 50 wt. % dry matter content based on the total weight of the liquid isomalt composition.

16. Food or luxury foods comprising the liquid isomalt composition according to claim 1.

17. A chewing gum comprising Use of the liquid isomalt composition according to claim 1 as a coating.
